(19) United States
(12) Patent Application Publication
(10) Pub. No.: US 2026/0093114 A1
(43) Pub. Date: Apr. 2, 2026

(54) OPTICAL DEVICE

(71) Applicant: Asia Optical Co., Inc., Taichung (TW)

(72) Inventors: Yue-Ye Chen, ShenZhen City (CN); Xiao-Yao Zhang, ShenZhen City (CN); Fang-Li Ma, ShenZhen City (CN); Lian Zhao, ShenZhen City (CN); Sheng Luo, ShenZhen City (CN); Hua-Tang Liu, Taichung (TW)

(21) Appl. No.: 19/318,548

(22) Filed: Sep. 4, 2025

(30) Foreign Application Priority Data
Sep. 27, 2024 (CN) 202411365665.2

(51) Int. Cl. G02B 27/01

(52) U.S. Cl. CPC G02B 27/0149; G02B 27/0101; G02B 2027/0154

(57) ABSTRACT

An optical device includes a prism module, a base element connected to the prism module, a first optical element, a first optical element carrier, and an adjustment assembly. The first optical element carrier is connected to the base element and carries the first optical element. The adjustment assembly includes an adjustable element, an elastic element, and a connecting element. The adjustable element and the connecting element respectively pass through the first optical element carrier and are movably connected to the base element. The elastic element is placed between and against the first optical element carrier and the base element. The first optical element carrier is moved along the connecting element or is rotated about the connecting element, when the adjustable element is adjusted relative to the base element to adjust an elastic force of the elastic element applied to the first optical element carrier and the base element.

### BACKGROUND OF THE INVENTION

### Field of the Invention

The invention relates to an optical device.

### Description of the Related Art

As shown in FIG. 1, a conventional rangefinder 59 includes an objective lens assembly (not shown), a prism module 51, an organic light emitting diode 52, a light emitter 53, a light receiver (not shown), and an eyepiece assembly (not shown). The prism module 51 is disposed between the objective lens assembly and the eyepiece assembly, and includes a first prism 54, a second prism 55, and a third prism 56.

During operation, a first light beam A emitted by an object (not shown) sequentially passes through the objective lens group, the second prism 55, the third prism 56 and the eyepiece group, so that the user can view the image of the object. A second light beam B emitted by the organic light emitting diode 52 is reflected by a reflector 57, and sequentially passes through the first prism 54, the second prism 55, the third prism 56 and the eyepiece group, so that the user can view the image information and the crosshairs generated by the organic light emitting diode 52. A third light beam C emitted by the light emitter 53 is reflected by another reflector 58, passes through the first prism 54, the second prism 55 and the objective lens group, reaches the object, and is reflected by the object back to the light receiver so as to calculate the distance between the object and the rangefinder 59.

However, the described rangefinder fails to fully meet user requirements, because adjustment of the light spot is not allowed or is inconvenient.

### BRIEF SUMMARY OF THE INVENTION

The invention provides an optical device that can adjust the light spot in order to address the technical problem that the light spot of the optical device in the prior art cannot be adjusted or the adjustment is inconvenient.

The optical device in accordance with an exemplary embodiment of the invention includes a prism module, a base element connected to the prism module, a first optical element, a first optical element carrier, and an adjustment assembly. The first optical element carrier is connected to the base element and configured to carry the first optical element. The adjustment assembly includes an adjustable element, an elastic element, and a connecting element. The adjustable element and the connecting element respectively pass through the first optical element carrier and are movably connected to the base element. The elastic element is placed between and against the first optical element carrier and the base element. The first optical element carrier is moved along the connecting element or is rotated about the connecting element, when the adjustable element is adjusted related to the base element so as to adjust an elastic force of the elastic element applied to the first optical element carrier and the base element.

In another exemplary embodiment, the adjustable element is connected to the base element through threads, and the elastic element is disposed around the adjustable element.

In yet another exemplary embodiment, the first optical element is configured to reflect light to the prism module, to reflect light coming from the prism module, or to emitting light to the prism module.

In another exemplary embodiment, the first optical element carrier is provided with an opening. The adjustable element is configured to pass through the opening of the first optical element carrier and is connected to the base element. The adjustable element includes a portion contained in the opening, and the opening is larger than the portion of the adjustable element.

In yet another exemplary embodiment, the opening of the first optical element carrier is configured for allowing the first optical element carrier to rotate with respect to the adjustable element when the first optical element carrier 102 is rotated with respect to the base element.

In another exemplary embodiment, the optical device further includes a printed circuit board assembly and a light emitter. The printed circuit board assembly includes a shielding cover and a printed circuit board disposed therein. The light emitter is electrically connected to the printed circuit board for emitting light to the first optical element.

In yet another exemplary embodiment, the optical device further includes a limiting element. The limiting element is a pressing plate which is bent as a whole. The limiting element includes a printed-circuit-board-assembly limiting portion, a carrier limiting portion, and an intermediate portion connected therebetween. The carrier limiting portion is fixedly connected to the base element, and holds the connecting element of the first optical element carrier. The printed-circuit-board-assembly limiting portion is propped against the printed circuit board assembly so that the printed circuit board assembly is limited from movement in a second direction and is movable in a first direction and in a third direction. The connecting element is axially extended in the first direction. The second direction is perpendicular to the first direction.

In another exemplary embodiment, the printed-circuit-board-assembly limiting portion and the intermediate portion have an included angle which is equal to or less than 90°, wherein the second direction and the third direction are perpendicular to the first direction.

In yet another exemplary embodiment, the optical device further includes a printed circuit board assembly and a light receiver. The printed circuit board assembly includes a shielding cover and a printed circuit board disposed therein. The light receiver is electrically connected to the printed circuit board for receiving light reflected by the first optical element.

In another exemplary embodiment, the optical device further includes a limiting element. The limiting element is a pressing plate which is bent as a whole. The limiting element includes a printed-circuit-board-assembly limiting portion, a carrier limiting portion, and an intermediate portion connected therebetween. The carrier limiting portion is fixedly connected to the base element, and holds the connecting element of the first optical element carrier. The printed-circuit-board-assembly limiting portion is propped against the printed circuit board assembly so that the printed circuit board assembly is limited from movement in a second direction and is movable in a first direction and in a third direction. The connecting element is axially extended in the first direction. The second direction is perpendicular to the first direction.

In yet another exemplary embodiment, the printed-circuit-board-assembly limiting portion and the intermediate portion have an included angle which is equal to or less than 90°. The second direction and the third direction are perpendicular to the first direction.

In another exemplary embodiment, the optical device further includes a printed circuit board assembly. The printed circuit board assembly includes a shielding cover and a printed circuit board disposed therein. The printed circuit board is disposed on the base element. The printed circuit board is linearly movable with respect to the base element to perform adjustment.

In yet another exemplary embodiment, the optical device further includes a limiting element. The limiting element is a pressing plate which is bent as a whole. The limiting element includes a printed-circuit-board-assembly limiting portion, a carrier limiting portion, and an intermediate portion connected therebetween. The carrier limiting portion is fixedly connected to the base element, and tightly holds the connecting element of the first optical element carrier. The printed-circuit-board-assembly limiting portion is propped against the printed circuit board assembly so that the printed circuit board assembly is limited from movement in a second direction and is movable in a first direction and in a third direction. The connecting element is axially extended in the first direction. The second direction is perpendicular to the first direction.

In another exemplary embodiment, the printed-circuit-board-assembly limiting portion and the intermediate portion have an included angle which is equal to or less than 90°. The second direction and the third direction are perpendicular to the first direction.

In yet another exemplary embodiment, the base element includes a shaft. The first optical element carrier includes a first supporting portion, a connecting element, and an adjustment assembly connecting portion. The first supporting portion is configured to support the first optical element. The connecting element is connected to the first supporting portion. The connecting element is rotatably connected to the shaft of the base element. The adjustment assembly connecting portion is fixedly connected to at least one of the first supporting portion and the connecting element. The adjustable element is configured to pass through the adjustment assembly connecting portion and is adjustably connected to the base element.

In another exemplary embodiment, the optical device further includes a carrier connecting portion which is fixed to the base element. The connecting element is disposed on one of the carrier connecting portion and the first optical element carrier, and a hole is provided on the other of the carrier connecting portion and the first optical element carrier to cooperate with the connecting element. The connecting element is axially extended in a first direction.

In yet another exemplary embodiment, the first optical element carrier is provided with an opening. The adjustable element is configured to pass through the opening of the first optical element carrier. The first optical element carrier includes a main body, a lug, and a first supporting portion. The lug is extended perpendicular to the first direction. The hole cooperating with the connecting element is provided on the lug. The lug is connected to a first side edge of the main body and is linearly movable along the connecting element and in the first direction. The first supporting portion is connected to a second side edge of the main body for supporting the first optical element. The opening on the first optical element carrier is disposed close to a third side edge of the main body.

In another exemplary embodiment, the optical device further includes a lens module disposed between the first optical element and the prism module. The carrier connecting portion includes a first portion, a second portion and a third portion. The first portion is fixed to the base element and is L-shaped. The second portion is angled with respect to the first portion. The connecting element is disposed on the second portion. The third portion is disposed around the lens module, and the lens module is linearly movable with respect to the third portion and in an optical axial direction of the lens module. The carrier connecting portion defines a lens adjustment groove extended in the optical axial direction of the lens module, and the lens module is configured to cooperate with the lens adjustment groove.

In yet another exemplary embodiment, the base element is a second base element. The optical device further includes a first base element. The first optical element carrier is connected to the first base element through the second base element. The connecting element is disposed on one of the second base element and the first optical element carrier, and a guide hole is provided on the other of the second base element and the first optical element carrier. The connecting element is configured to cooperate with the guide hole. The connecting element and the guide hole are both extended in a first direction. The connecting element is axially extended in the first direction.

The optical device of the invention is capable of adjusting the light spot in a direction by adjusting the reflector which cooperates with the prism module, and the adjustment of the reflector is convenient. Further, the optical device of the invention is capable of adjusting the light spot in another direction by adjusting the printed circuit board assembly. Further, in the invention, the focal length of the entire optical device can be adjusted by adjusting the lens frame.

### BRIEF DESCRIPTION OF THE DRAWINGS

The invention can be more fully understood by reading the subsequent detailed description and examples with references made to the accompanying drawings, wherein:

FIG. 1 is a schematic view showing the structure of a conventional rangefinder.

FIG. 2A is a schematic view of an optical system in accordance with an embodiment of the invention.

FIG. 2B is a schematic view of a prism module of the optical system of FIG. 2A.

FIG. 3 is a perspective diagram of a light emitting system of an optical device in accordance with another embodiment of the invention.

FIG. 4 is another perspective diagram of the light emitting system shown in FIG. 3.

FIG. 5 is an exploded diagram of the light emitting system shown in FIG. 3.

FIG. 6 is an exploded diagram of a light emitting system in accordance with a variation embodiment of FIG. 3, with the prism module therein removed.

FIG. 7 is a perspective diagram of a light receiving system in an optical device in accordance with another embodiment of the invention.

FIG. 8 is another perspective diagram of the light receiving system shown in FIG. 7.

FIG. 9 is an exploded view of the light receiving system shown in FIG. 7.

FIG. 10 is a schematic diagram of some elements of the light receiving system shown in FIG. 9.

FIG. 11 is an exploded schematic view of a display module in an optical device in accordance with another embodiment of the invention.

FIG. 12 is another exploded schematic view of the display module shown in FIG. 11.

FIG. 13 is a schematic view of the display module shown in FIG. 11.

FIG. 14 is a schematic view of the display module shown in FIG. 11 with a part of structure removed.

FIG. 15 is a schematic view of the display module shown in FIG. 11 with another part of the structure removed.

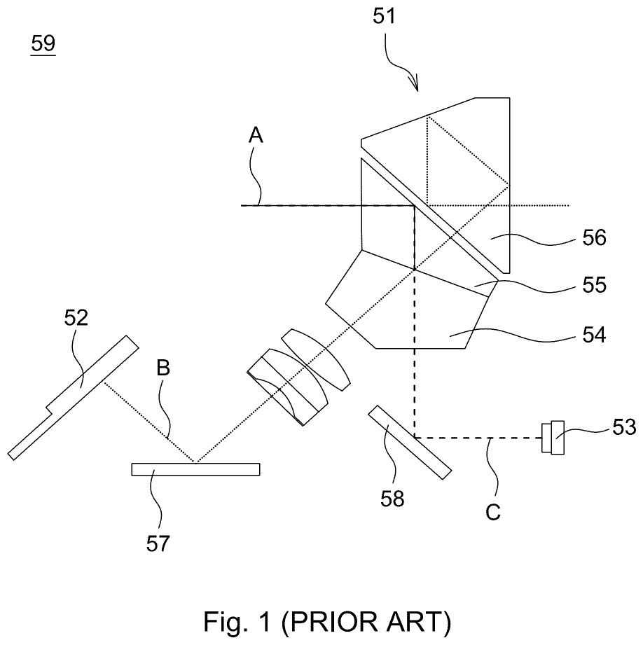

### DETAILED DESCRIPTION OF THE INVENTION

The purpose, technical scheme and merits of the invention can be more fully understood by reading the subsequent detailed description and embodiments with references made to the accompanying drawings. However, it is understood that the subsequent detailed description and embodiments are only used for describing the invention. The invention is not limited thereto.

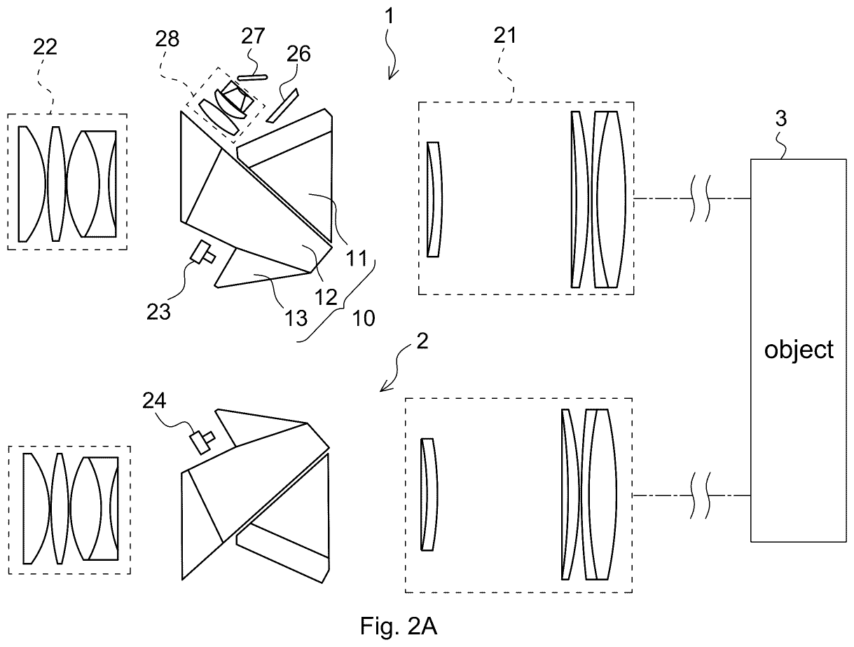

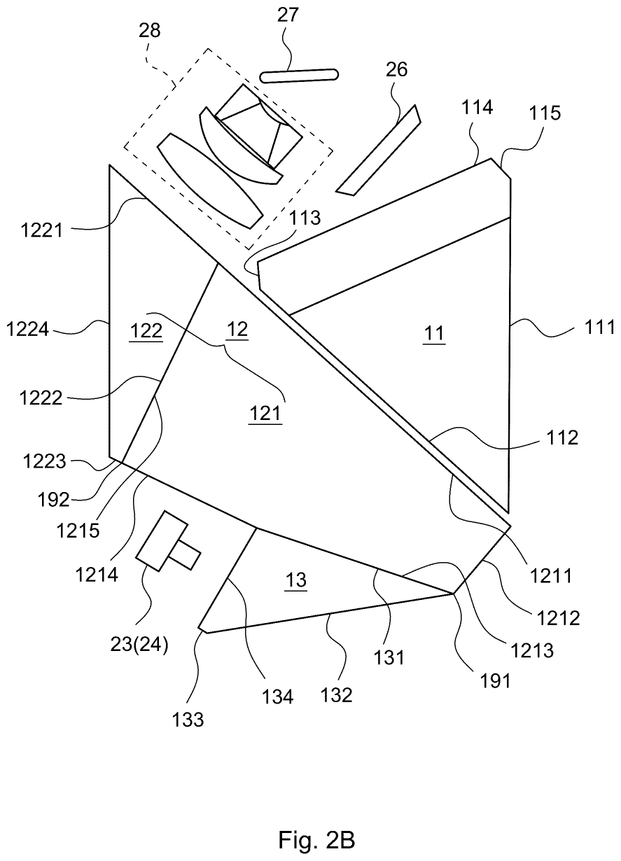

Referring to FIGS. 2A and 2B, an optical device of an embodiment of the invention are binoculars with a distance measuring function, which includes two optical systems 1 and 2. The difference between the two optical systems 1 and 2 is that the optical system 1 is provided with a light emitter 23, while the optical system 2 is provided with a light receiver 24. Other elements and arrangements thereof are substantially the same. The optical system 1 is provided in the light emitting system of the optical device, and the optical system 2 is provided in the light receiving system of the optical device.

In this embodiment, the optical system 1 includes an objective lens unit 21, an eyepiece unit 22, a display 26, a reflector 27, a lens group 28, a prism module 10, and a light emitter 23. A first light beam emitted by an object 3 sequentially passes through the objective lens unit 21, the prism module 10, and the eyepiece unit 22. A second light beam emitted by the display 26 is reflected by the reflector 27, and sequentially passes through the lens group 28, the prism module 10, and the eyepiece unit 22. A third light beam emitted by the light emitter 23 sequentially passes through the prism module 10 and the objective lens unit 21, reaches the object 3, is reflected by the object 3 back to the optical system 2 of the binoculars, and is received by the light receiver 24. With such arrangement, the user can view the image of the object 3 and the image generated by the display 26 through the eyepiece unit 22, and can know the distance between the object 3 and the binoculars.

The prism module 10 may include a plurality of prisms. The prism module 10 of this embodiment shown in FIGS. 2A and 2B is only an example. However, the invention is not limited thereto. The prism module 10 may be built in other forms. In this embodiment, the prism module 10 is disposed between the objective lens unit 21 and the eyepiece unit 22, and includes a first prism 11, a second prism 12, and a third prism 13.

In this embodiment, the first prism 11 is a roof prism and includes a first surface 111, a second surface 112, a thirteenth surface 113, a third surface 114 and a fourteenth surface 115 connected to each other. Specifically, in the first embodiment, the first surface 111 adjoins the second surface 112, the thirteenth surface 113 adjoins both the second surface 112 and the third surface 114, and the fourteenth surface 115 adjoins both the third surface 114 and the first surface 111. It is worth noting that the third surface 114 is disposed opposite to the included angle between the first surface 111 and the second surface 112.

The second prism 12 is disposed beside the first prism 11 and has a gap provided therebetween. In the first embodiment, the second prism 12 is a half-penta prism and includes a first portion 121 and a second portion 122. The first portion 121 includes a fourth surface 1211, a fifteenth surface 1212, a fifth surface 1213, a sixteenth surface 1214, and a sixth surface 1215 connected to each other. Specifically, the fourth surface 1211 faces the second surface 112, the fifteenth surface 1212 adjoins the fourth surface 1211 and the fifth surface 1213, the fifth surface 1213 is disposed opposite to the fourth surface 1211, the sixteenth surface 1214 adjoins the fifth surface 1213, and the sixth surface 1215 adjoins the fourth surface 1211 and the sixteenth surface 1214. The second portion 122 includes a seventh surface 1222, a seventeenth surface 1223, an eighth surface 1224 and a ninth surface 1221 which are connected to each other. Specifically, the seventh surface 1222 faces the sixth surface 1215, the eighth surface 1224 is disposed opposite to the seventh surface 1222, and the ninth surface 1221 adjoins both the seventh surface 1222 and the eighth surface 1224.

In this embodiment, a film 192 may be disposed between the first portion 121 and the second portion 122. Specifically, the film 192 is disposed between the seventh surface 1222 and the sixth surface 1215. The film 192 may be formed on the seventh surface 1222 or the sixth surface 1215 before the first portion 121 and the second portion 122 are combined. The film 192 allows visible light of a specific wavelength (such as the aforementioned first light beam) to pass through but reflects visible light of another specific wavelength (such as the aforementioned second light beam).

The third prism 13 is attached to the second prism 12. In the first embodiment, the third prism 13 is a triangular prism and includes a tenth surface 131, an eleventh surface 132, an eighteenth surface 133, and a twelfth surface 134 which are connected to each other. Specifically, the tenth surface 131 adjoins both the eleventh surface 132 and the twelfth surface 134, and the eighteenth surface 133 adjoins both the eleventh surface 132 and the twelfth surface 134 and is disposed opposite to the tenth surface 131.

In this embodiment, another film 191 is disposed between the second prism 12 and the third prism 13. Specifically, the film 191 is disposed between the fifth surface 1213 and the tenth surface 131. The film 191 may be formed on the fifth surface 1213 or the tenth surface 131 before the second prism 12 and the third prism 13 are combined. The film 191 allows visible light of a specific wavelength (such as the aforementioned first light beam) to pass through but reflects invisible light of a specific wavelength (such as the aforementioned third light beam).

In other embodiments, the first prism 11, the second prism 12, and the third prism 13 may be combined in other forms, and the prism module 10 may be built in other forms.

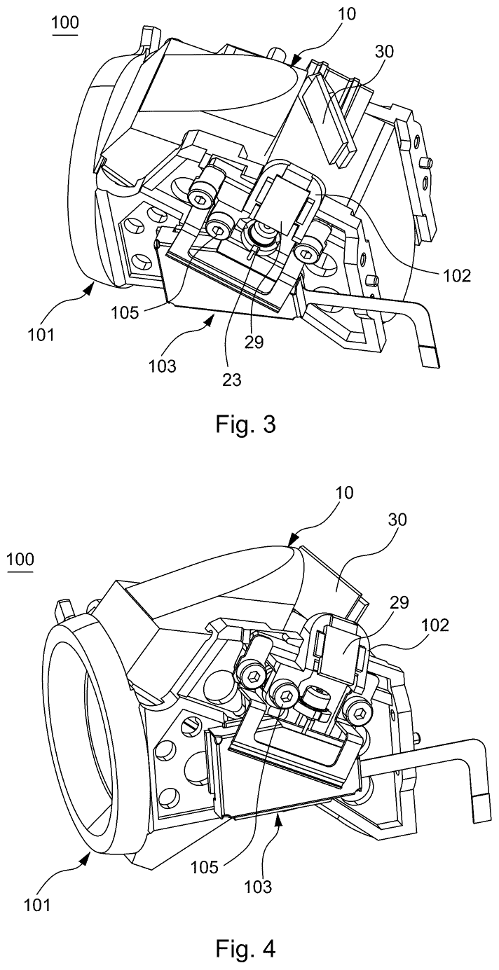

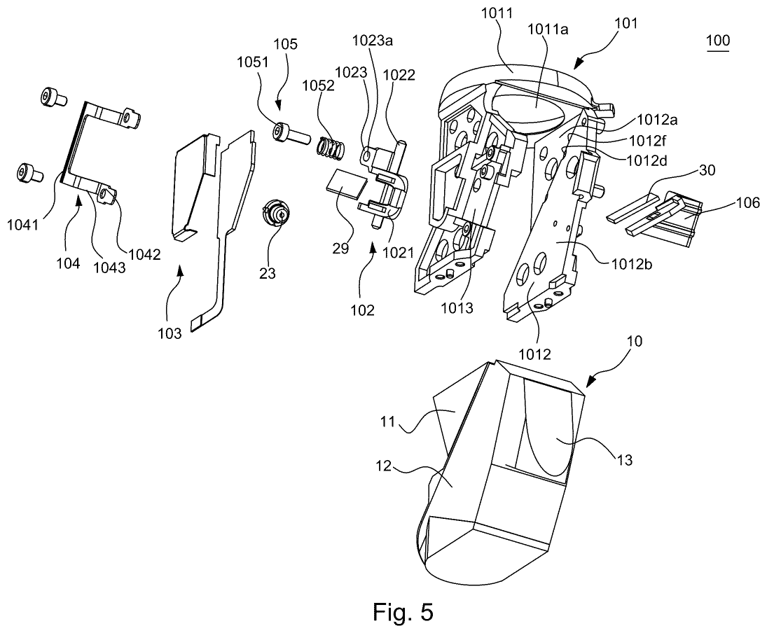

FIG. 3 is a perspective diagram of a light emitting system of an optical device in accordance with another embodiment of the invention, FIG. 4 is another perspective diagram of the light emitting system shown in FIG. 3, and FIG. 5 is an exploded diagram of the light emitting system shown in FIG. 3. As shown in FIG. 3 through FIG. 5, the light emitting system 100 of the optical device includes a prism module 10, a first base element 101, a first optical element 29, a first optical element carrier 102, a printed circuit board (PCB) assembly 103, and an adjustment assembly 105. The first base element 101 is configured to support the prism module 10. The first optical element 29 is configured for reflecting light to the prism module 10 or reflecting light coming from the prism module 10. The first optical element carrier 102 is connected to the first base element 101 and is configured to support the first optical element 29. The adjustment assembly 105 is configured for adjusting the first optical element carrier 102, so as to adjust the light spot. In this embodiment, the first optical element 29 is a reflector, configured for reflecting light to the prism module 10 or reflecting light coming from the prism module 10. It does not mean that the light must be directly reflected to the prism module 10 or the light coming from the prism module 10 must be directly reflected. Other reflectors may be provided between the first optical element 29 and the prism module 10.

The structure of the light receiving system 200 of the optical device of this embodiment is basically the same as that of the light emitting system 100. The only difference between the two systems is that the light emitting system 100 is provided with a light emitter 23, while the light receiving system 200 is provided with a light receiver 24 (as shown in FIG. 2A).

As shown in FIG. 3 through FIG. 5, the first base element 101 includes a first base portion 1011, a second base portion 1012 and a third base portion 1013. The first base portion 1011 is provided with a hole 1011a for light to pass through. In the illustrated embodiment, the first base portion 1011 is substantially annular. The second base portion 1012 and the third base portion 1013 are substantially plate-shaped. Each of the second base portion 1012 and the third base portion 1013 has an end connected to the same side of the first base portion 1011 and extended in a direction parallel to the axis of the hole 1011a of the first base portion 1011. The second base portion 1012 and the third base portion 1013 are respectively located on opposite sides of the hole 1011a to avoid interference with the light which entering the first base element 101 from the hole 1011a. In the illustrated embodiment, the first base portion through the third base portion 1011-1013 are disposed together to form a receiving space, and the above-mentioned prism module 10 is disposed therein.

The second base portion 1012 and the third base portion 1013 have inner surfaces facing each other, on which first limiting portions are provided. The first limiting portions and the first base portion 1011 jointly limit the first prism 11 of the prism module 10 in the direction parallel to the axis of the hole 1011a. In this embodiment, the second base portion 1012 is taken for describing the first limiting portion. The second base portion 1012 has a first portion 1012a disposed close to the first base portion 1011 and a second portion 1012b disposed distant from the first base portion 1011. The thickness of the first portion 1012a is less than that of the second portion 1012b so that the inner surface of the second base portion 1012 is formed into a step surface 1012f corresponding to the first base portion 1011, which functions as the first limiting portion. The first prism 11 has a surface (for example, the first surface 111) propped against the first base portion 1011, and an opposite surface (for example, the second surface 112) propped against the step surface 1012f, whereby the first prism 11 is limited in the direction parallel to the axis of the hole 1011a.

In the invention, the first limiting portions may be modified to have structures in other forms. For example, the second base portion 1012 and the third base portion 1013 may individually have a through hole 1012d formed on their inner surfaces which face each other, and disposed below the step surface 1012f. Glue can be applied to the through hole 1012d so as to bond and fix the first prism 11 and the first base element 101.

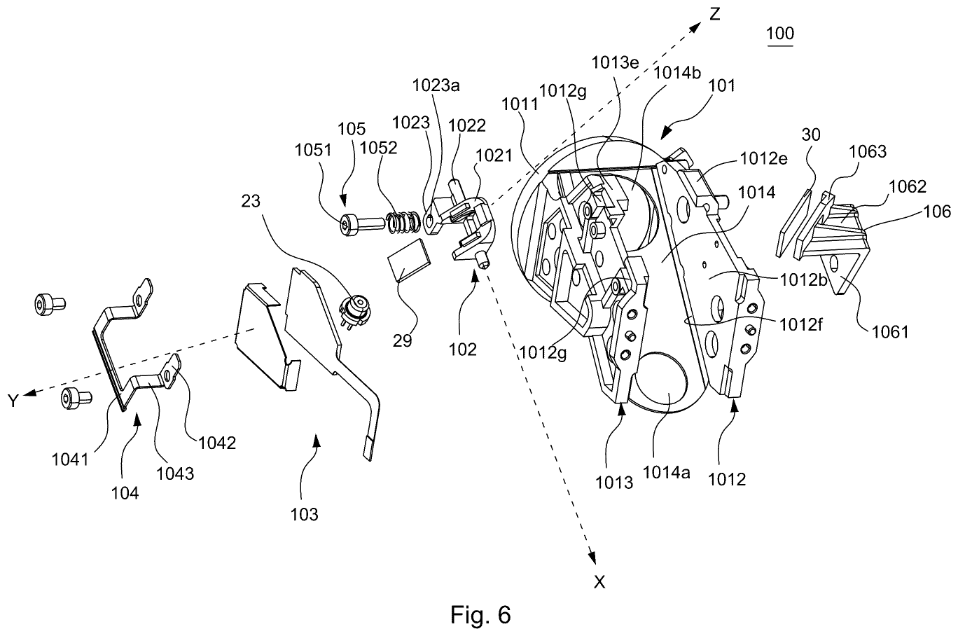

In a variation embodiment, the first base element 101 further includes a spacer 1014 as shown in FIG. 6. The main body of the spacer 1014 is generally in the shape of a thin plate. A plurality of through holes 1014a, 1014b are provided on the spacer 1014. The through holes 1014a, 1014b allow light beams traveling on different paths or on the same path in different directions to pass through, so as to avoid mutual interferences therebetween. The spacer 1014 is propped against the step surface 1012f and also against the second surface 112 of the first prism 11, thereby capable of limiting the first prism 11. The main body of the spacer 1014 has ears provided on both sides thereof. The ears are extended toward the first base portion 1011, perpendicular to the main body of the spacer 1014, and parallel to the inner surfaces of the second base portion 1012 and the third base portion 1013. Further, the ears are placed in contact with the inner surfaces of the second base portion 1012 and the third base portion 1013, so as to facilitate the positioning of the spacer 1014.

The second base portion 1012 and the third base portion 1013 further have second limiting portions 1012e and 1013e provided thereon. The second limiting portions 1012e and 1013e extend toward each other from the side edges of the second base portion 1012 and the third base portion 1013 in the direction perpendicular to the second base portion 1012 and the third base portion 1013. When the second prism 12 is installed, the second limiting portions 1012e and 1013e and the second surface 112 of the first prism 11 jointly limit the second prism 12. In this variation embodiment in which the spacer 1014 is provided, the second limiting portions 1012e and 1013e and the spacer 1014 disposed opposite to each other jointly limit the second prism 12, wherein the fourth surface 1211 is propped against the spacer 1014, and the fifth surface 1213 is propped against the second limiting portions 1012e and 1013e. Similarly, through holes are provided on the second portion 1012b, and the second prism 12 and the first base element 101 can be bonded and fixed by applying glue to the through holes.

When the prism module 10 includes the third prism 13, the third prism 13 may be bonded and fixed to the second prism 12, for example, fixed to the fifth surface 1213.

The first optical element carrier 102 is connected to the first base element 101 for supporting the first optical element 29. The first optical element 29 may be a reflector. In the light emitting system 100, the first optical element 29 is used to reflect the light emitted by the light emitter 23 so that it travels to the prism module 10, for example, the third prism 13. In the light receiving system 200, the first optical element 29 is used to reflect the light to the light receiver 24 that is emitted from the prism module 10. As described, the optical device includes the first optical element 29. It is worth noting that the optical device may further include a second optical element 30 that cooperates with the first optical element 29. The second optical element 30 may be a reflector. The light travels after being reflected by the first optical element 29 and the second optical element 30.

The first optical element carrier 102 is rotatably connected to the outer surface of one of the second base portion 1012 and the third base portion 1013 and is disposed close to the side edge thereof. In the illustrated embodiment, the first optical element carrier 102 is connected to the third base portion 1013 and is disposed close to the second limiting portion 1013e.

The first optical element carrier 102 includes a first supporting portion 1021, a connecting element 1022, and an adjustment assembly connecting portion 1023. The first supporting portion 1021 is used to support the first optical element 29. The connecting element 1022 is connected to the first supporting portion 1021, wherein the connecting element 1022 has a fixed end connected to the first supporting portion 1021, and a free end disposed opposite to the fixed end. The adjustment assembly connecting portion 1023 is fixedly connected to at least one of the first supporting portion 1021 and the connecting element 1022. The connecting element 1022 may be a connecting shaft which extends in a first direction X (the axial direction), with the fixed end and the free end of the connecting element 1022 arranged in the axial direction. That is, the axial direction of the connecting element 1022 is parallel to the first direction X. The first supporting portion 1021 and the adjustment assembly connecting portion 1023 are respectively fixed to the connecting element 1022 and extended in opposite directions and away from the connecting element 1022. The second base portion 1012 is provided with limiting grooves 1012g, and the connecting element 1022 is disposed in the limiting grooves 1012g. The length of each limiting groove 1012g is equal to the distance between the two ends of the connecting element 1022, so that the connecting element 1022 cannot be moved linearly in the axial direction (i.e. the first direction X).

The PCB assembly 103 includes a shielding cover and a PCB disposed therein. The PCB assembly 103 is placed on one of the second base portion 1012 and the third base portion 1013 and is connected to the light emitter 23 and/or the light receiver 24.

The light emitting system 100 further includes a limiting element 104, which is used to limit the first optical element carrier 102 and the printed circuit board assembly 103 relative to the first base element 101. Since the printed circuit board assembly 103 has a predetermined thickness, the height of the printed circuit board assembly 103 is greater than that of the connecting element 1022. In the illustrated embodiment, the limiting element 104 may be a pressing plate, which is bent as a whole and includes a printed-circuit-board-assembly limiting portion 1041, a carrier limiting portion 1042, and an intermediate portion 1043 connected therebetween. The printed-circuit-board-assembly limiting portion 1041 and the intermediate portion 1043 have an included angle therebetween that is not greater than 90°. The carrier limiting portion 1042 is connected to the one of the second base portion 1012 and the third base portion 1013 through the connecting element 1022, presses the connecting element 1022, and prevents the connecting element 1022 from linearly moving. The printed-circuit-board-assembly limiting portion 1041 is configured to limit the printed circuit board assembly 103 in a second direction Y so that the printed circuit board assembly 103 cannot move in a direction to push against the printed circuit board assembly stopper 1041, but can move in the axial direction of the connecting element 1022 (i.e., the first direction X) and in a third direction Z perpendicular to the axial direction for adjustment, so as to achieve the position adjustment and focal length adjustment of the light spot.

An adjustment assembly 105 is provided on the one of the second base portion 1012 and the third base portion 1013. The adjustment assembly 105 includes an adjustable element 1051 and an elastic element 1052. The adjustable element 1051 is configured to pass through the first optical element carrier 102 and is adjustably connected to the one of the second base portion 1012 and the third base portion 1013. The elastic element 1052 is placed between and against the first optical element carrier 102 and the first base element 101 and constantly exerts an elastic force on the first optical element carrier 102 in a direction away from the first base element 101, so that the adjustable element 1051 is in tension. When the adjustable element 1051 is adjusted with respect to the first base element 101, the first optical element carrier 102 is rotated about the connecting element 1022 and with respect to the first base element 101.

In the illustrated embodiment, the adjustable element 1051 is a bolt connected to the one of the second base portion 1012 and the third base portion 1013 with threads. The elastic element 1052 is disposed around the shank of the bolt 1051. The adjustment assembly connecting portion 1023 of the first optical element carrier 102 is provided with a hole 1023a. The bolt 1051 is configured to pass through the hole 1023a and is connected to the first base element 101. The elastic element 1052 constantly exerts an elastic force to the adjustment assembly connecting portion 1023, which forces the adjustment assembly connecting portion 1023 against the head of the bolt 1051 to keep it fixed.

When the first optical element 29 needs to be adjusted, the bolt 1051 is rotated to change its height, and the first optical element carrier 102 is rotated around the connecting element 1022 accordingly, so that the position of the light spot can be adjusted. In order to avoid mechanical jamming, the hole 1023a can be elongated, or the hole 1023a is larger than the portion of the adjustable element 1051 contained therein, thereby providing a space for the first optical element carrier 102 to rotate relative to the adjustable element 1051. For example, the elongated hole can extend in a direction perpendicular to the first direction X, or the hole has a measurement in the direction perpendicular to the first direction X that is larger than the portion of the adjustable element 1051 contained in the hole.

The second optical element 30 is fixed by the second optical element carrier 106 which includes a first portion 1061, a second portion 1062 and a second supporting portion 1063. The first portion 1061 is fixed to the other of the second base 1012 and the third base 1013. The second portion 1062 is connected to the first portion 1061 at an angle. The second supporting portion 1063 is connected to an end of the second portion 1062. The second portion 1062 extends from the first portion 1061 to the space between the second base 1012 and the third base 1013. The second optical element 30 is fixed to the second supporting portion 1063 at the end of the second portion 1062. The first portion 1061 and the second portion 1062 may be arranged at a right angle.

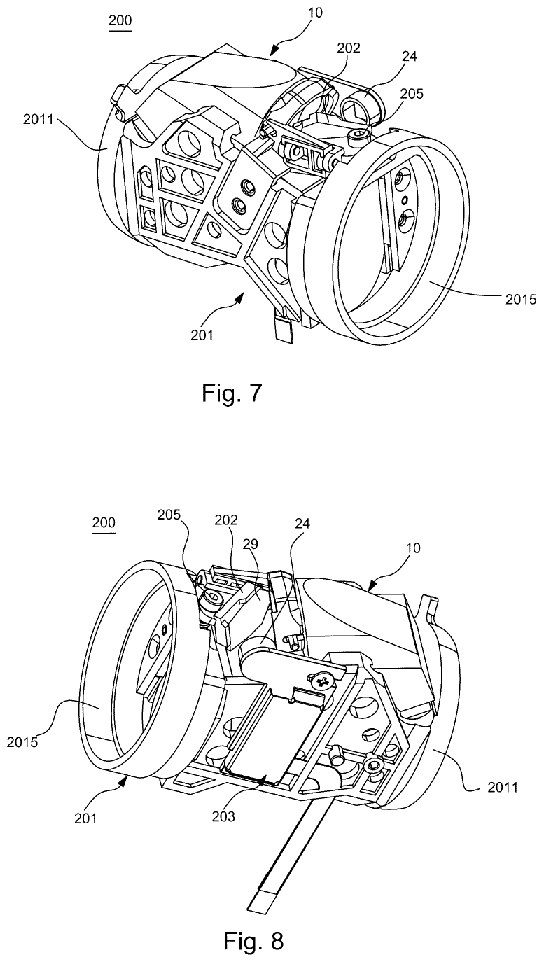

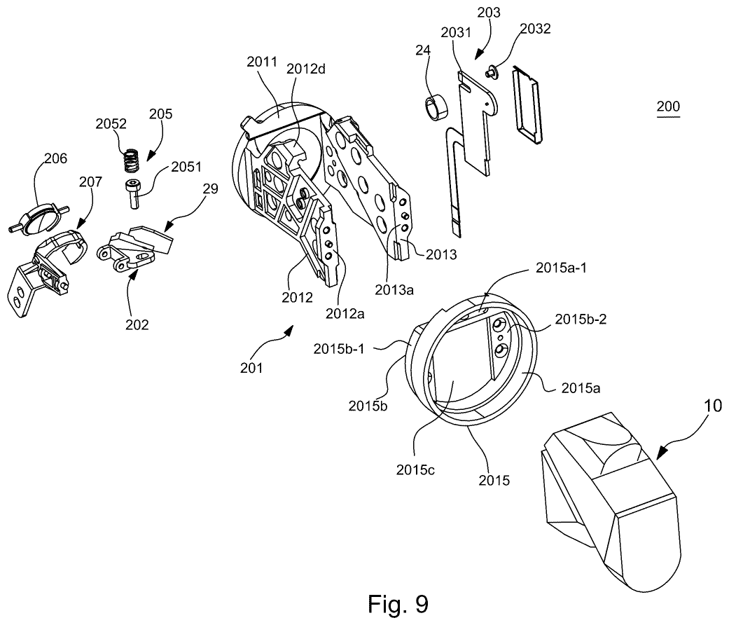

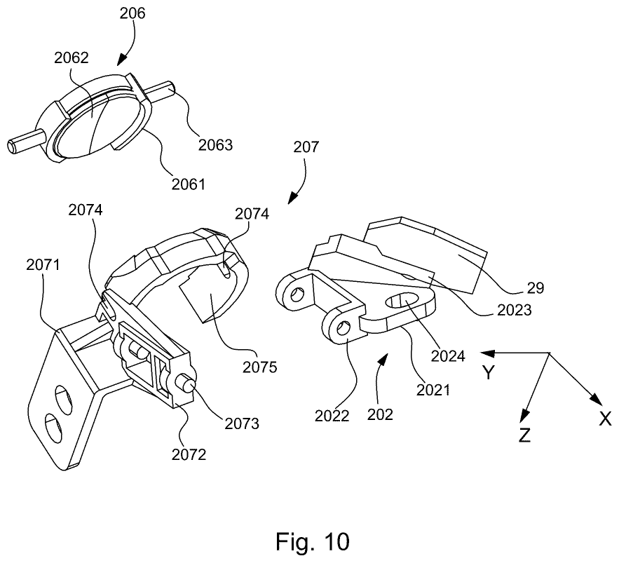

Referring to FIGS. 7-10, FIG. 7 is a perspective diagram of a light receiving system in an optical device in accordance with another embodiment of the invention, FIG. 8 is another perspective diagram of the light receiving system shown in FIG. 7, FIG. 9 is an exploded view of the light receiving system shown in FIG. 7, and FIG. 10 is a schematic diagram of some elements of the light receiving system shown in FIG. 9. Similar to the above embodiments, the structure of the light receiving system 200 can also be applied to that of the light emitting system 100. The only difference between the two systems is that the light emitting system 100 is provided with a light emitter 23, while the light receiving system 200 is provided with a light receiver 24. For simplification, the same parts as those of the above embodiments are not described in the following.

In this embodiment, the light receiving system 200 of the optical device includes a prism module 10, a first base element 201, a first optical element 29, a first optical element carrier 202, a printed circuit board assembly 203, and an adjustment assembly 205. The prism module 10 is connected to and fixed to the first base element 201. The first optical element carrier 202 is connected to the first base element 201 and is used to support the first optical element 29. The adjustment assembly 205 is used to adjust the first optical element carrier 202, so as to adjust the light spot. In this embodiment, the first optical element 29 can be, for example, a reflector.

The first base element 201 includes a first base portion 2011, a second base portion 2012 and a third base portion 2013. Further, the first base element 201 includes a fourth base portion 2015. Similar to the above embodiments, the second base portion 2012 and the third base portion 2013 are substantially plate-shaped, and each of the second base portion 2012 and the third base portion 2013 has an end connected to the same side of the first base portion 2011, and has the other end connected to the fourth base portion 2015. That is, the second base portion 2012 and the third base portion 2013 are disposed between and connected to the first base portion 2011 and the fourth base portion 2015. The fourth base portion 2015 is substantially annular or cylindrical, and can be used to limit the displacement of the prism module 10 along its axial direction. In this embodiment, the fourth base portion 2015 includes a first portion 2015a which is annular, and a second portion 2015b fixedly connected to the first portion 2015a in the axial direction. The second portion 2015b has an outer dimension smaller than that of the first portion 2015a, and includes a substantially D-shaped peripheral wall 2015b-1, and bottom walls 2015b-2 connected to the peripheral wall 2015b-1. The number of the bottom walls 2015b-2 may be two, wherein the two bottom walls 2015-b are oppositely arranged. However, the invention is not limited thereto. For example, the number of the bottom wall 2015b-2 may be one, and the bottom wall 2015b-2 is a unitary structure. The bottom wall(s) 2015b-2 may be perpendicular to the axis of the first portion 2015a.

The other end of each of the second base portion 2012 and the third base portion 2013 is respectively provided with folded edges 2012a and 2013a corresponding to the bottom wall 2015b-2. The bottom wall 2015b-2 is connected to the folded edges 2012a and 2013a in the axial direction of the fourth base portion 2015 through a connecting piece so as to fix the fourth base portion 2015.

The second portion 2015b includes an arc-shaped portion and a straight portion which are connected to each other to form a D-shaped outer contour. The straight portion has an end close to the second base portion 2012, and another end close to the third base portion 2013. The two bottom walls 2015b-2 may be connected to the two ends of the straight portion respectively. In this embodiment, the central angle of the arc-shaped portion is greater than 180°. The bottom walls 2015b-2 and the peripheral wall 2015b-1 jointly define a light hole 2015c corresponding to the prism module 10. A fixing post is provided on the outer surface of the straight portion of the peripheral wall 2015b-1. The fixing post can be extended in a direction perpendicular to the axial direction of the first portion 2015a, or disposed to have an acute angle with respect to the axial direction. The first portion 2015a is provided with an avoidance opening 2015a-1 corresponding to the fixing post.

The printed circuit board assembly 203 is fixed to one of the second base portion 2012 and the third base portion 2013, and the light receiver 24 protrudes from the side edge of the one of the second base portion 2012 and the third base portion 2013. The first optical element carrier 202 is connected to the other of the second base portion 2012 and the third base portion 2013, so that the light receiver disposed on the printed circuit board assembly 203 and the first optical element 29 supported by the first optical element carrier 202 are opposite to each other. The printed circuit board assembly 203 includes an adjustment groove 2031 and a printed circuit board connector 2032. The adjustment groove 2031 can penetrate the shielding cover and the printed circuit board of the printed circuit board assembly 203, and the printed circuit board connector 2032 is configured to pass through the adjustment groove 2031 and connected to the first base element 201. By such arrangement, an adjustment can be performed by moving the shielding cover and the printed circuit board with respect to the printed circuit board connector 2032. Alternatively, the adjustment groove 2031 may be configured to penetrate only the printed circuit board, and the printed circuit board can be adjusted solely, so as to adjust the receiver 24 disposed thereon.

The light receiving system 200 further includes a carrier connecting portion 207, which is fixed to one of the second base portion 2012 and the third base portion 2013. A rotating shaft is provided on one of the carrier connecting portion 207 and the first optical element carrier 202, while a hole matching the rotating shaft is disposed on the other of the carrier connecting portion 207 and the first optical element carrier 202.

In the illustrated embodiment, the carrier connecting portion 207 includes a first portion 2071 fixed to the other of the second base portion 2012 and the third base portion 2013, and a second portion 2072 angled with respect to the first portion 2071. The first portion 2071 is generally L-shaped, and fixed to the other of the second base portion 2012 and the third base portion 2013. Further, the first portion 2071 is bent and extended to the upper side edge of the other of the second base portion 2012 and the third base portion 2013 and is disposed close to the second limiting portion 2012d.

The second portion 2072 extends from the first portion 2071 toward the fourth base portion 2015, and a connecting element 2073 is disposed on the second portion 2072 and extends in the first direction X. In the illustrated embodiment, the second portion 2072 may be substantially parallel to the second base portion 2012 and the third base portion 2013.

The first optical element carrier 202 has a side disposed around the connecting element 2073, so that the first optical element carrier 202 can move linearly along the connecting element 2073 in the first direction X and can rotate around the connecting element 2073. The first direction X is parallel to the axis of the annular first portion 2015a of the fourth base portion 2015, and has an acute angle with respect to the side edges of the second base portion 2012 and the third base portion 2013.

An adjustment assembly 205 is disposed on the fourth base portion 2015. The adjustment assembly 205 includes an adjustable element 2051 and an elastic element 2052. The adjustable element 2051 passes through an opening 2024 in the first optical element carrier 202 and is adjustably connected to the fourth base portion 2015, for example, to the straight portion of the second portion 2015b of the fourth base portion 2015. The elastic element 2052 is placed between and against the first optical element carrier 202 and the first base element 201 and constantly exerts an elastic force on the first optical element carrier 202 in a direction away from the first base element 201, so that the adjustable element 2051 is in tension. When the adjustable element 2051 is adjusted relative to the first base element 201, the first optical element carrier 202 rotates relative to the first base element 201. The structure of the adjustable element 2051 is the same as that of the adjustable element 1051 in the above embodiment.

In the illustrated embodiment, the first optical element carrier 202 includes three parts: a main body 2021, lugs 2022, and a supporting portion 2023. The main body 2021 may be substantially in the shape of a triangular plate, and extended to be parallel to the first direction X. The lugs 2022 are extended perpendicular to the first direction X and connected to the first side edge of the main body 2021. The number of the lugs 2022 may be two. The lugs 2022 have holes provided thereon and are disposed around the connecting elements 2073 by using the holes. The supporting portion 2023 is connected to the second side edge of the main body 2021, and the supporting portion 2023 and the main body 2021 may have an acute angle therebetween. The supporting portion 2023 is used to directly support the first optical element 29. The opening 2024 on the first optical element carrier 202 is disposed close to the third side edge of the main body 2021.

The light receiving system 200 further includes a lens module 206. Lens adjustment grooves 2074 are provided on the carrier connecting portion 207. The lens module 206 is disposed between the reflector and the prism module 10, for example, between the first optical element 29 and the prism module 10 shown in the figures. The lens adjustment grooves 2074 extend in the optical axis direction of the lens module 206, and the optical axis direction may have an acute angle with respect to the first direction X, for example, 45°. The lens module 206 includes a lens frame 2061 and a lens 2062 disposed in the lens frame 2061. Two sides of the lens frame 2061 are provided with lens frame shafts 2063, which extend perpendicular to the third direction Z and cooperates with the lens adjustment grooves 2074. The lens frame shafts 2063 are movable in the lens adjustment grooves 2074 in the third direction Z and the lens frame 2061 is rotatable around the lens frame shafts 2063.

Specifically, in the illustrated embodiment, the carrier connecting portion 207 further includes a third portion 2075, and the third portion 2075 and the first portion 2071 may be respectively located on both sides of the second portion 2072. The third portion 2075 may be annular or arc-shaped, and disposed around the lens frame 2061. The lens adjustment grooves 2074 are provided on the third portion 2075 and extend to the second portion 2072.

By providing a guide protrusion on the inner surface of the third part 2075 and correspondingly providing a guide recess on the outer surface of the mirror frame 2061, the lens frame 2061 cannot be rotated but linearly moved in the third direction Z.

The light receiving system 200 in this embodiment can also be applied to the light emitting system 100, which will not be described in detail here. Further, an embodiment in which the light emitting system 100 and the light receiving system 200 have the same structure is described above. However, the invention is not limited thereto. It is feasible that one of the light emitting system 100 and the light receiving system 200 has a structure as described in the above embodiment, and the other of the light emitting system 100 and the light receiving system 200 has a different structure.

The optical device of the invention is capable of adjusting the light spot in a direction by adjusting the reflector which cooperates with the prism module 10, and the adjustment of the reflector is convenient. Further, the optical device of the invention is capable of adjusting the light spot in another direction by adjusting the printed circuit board assembly. Further, in the invention, the focal length of the entire optical device can be adjusted by adjusting the lens frame 2061.

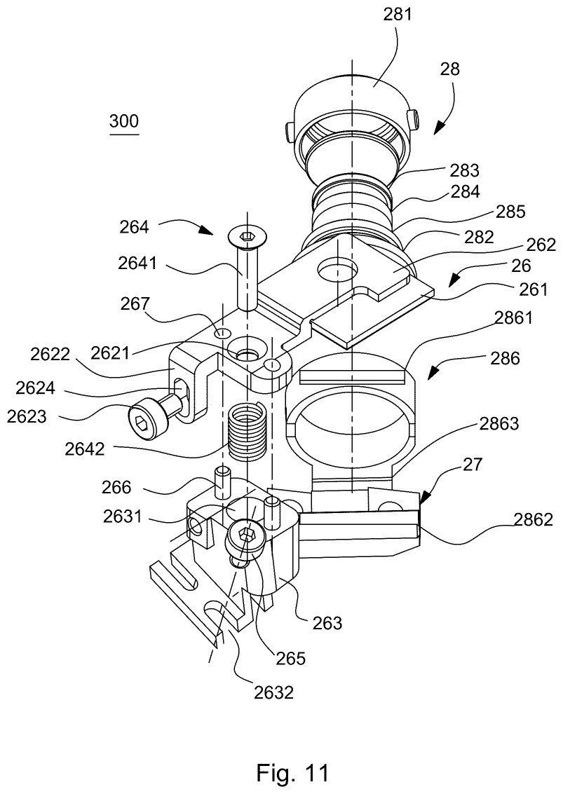

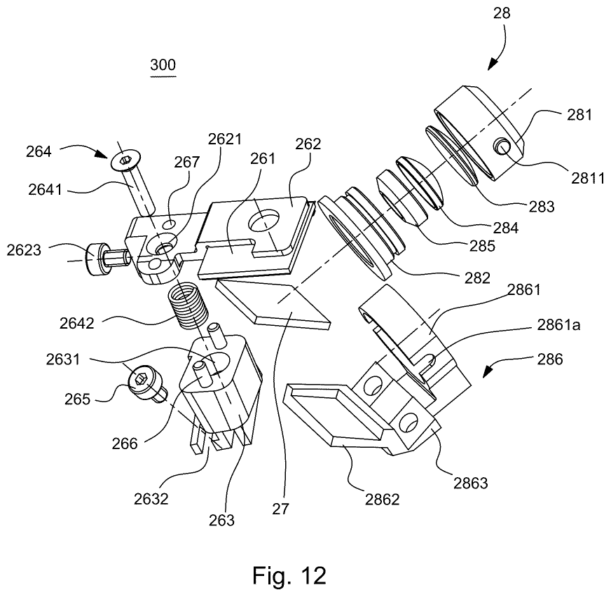

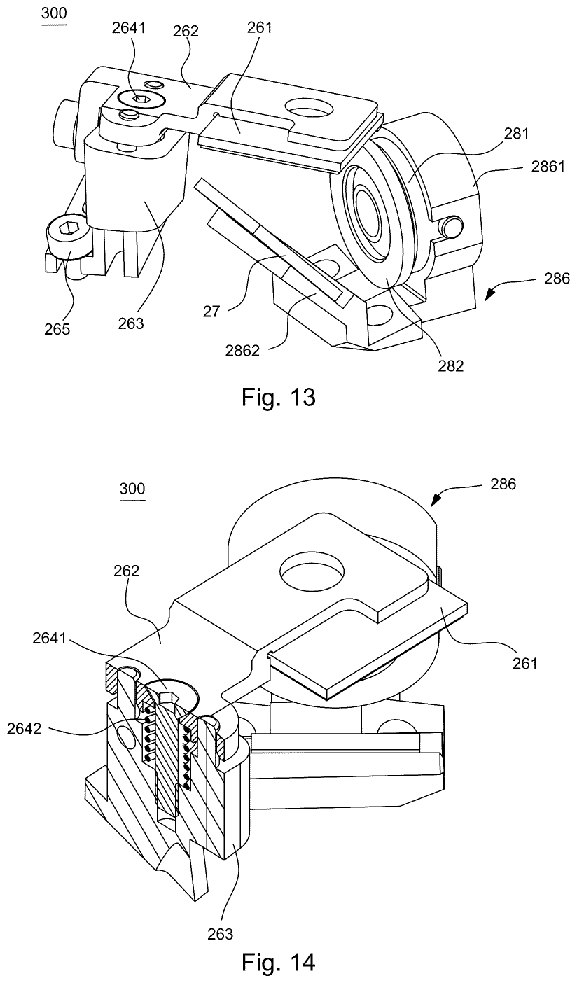

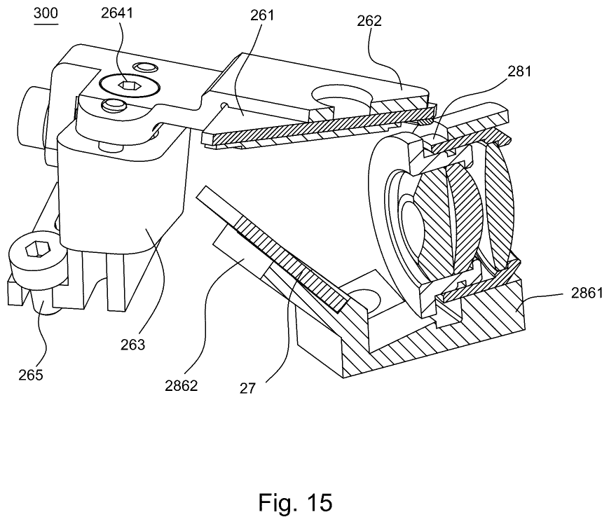

Referring to FIGS. 11-15, FIG. 11 is an exploded schematic view of a display module in an optical device in accordance with another embodiment of the invention, FIG. 12 is another exploded schematic view of the display module shown in FIG. 11, FIG. 13 is a schematic view of the display module shown in FIG. 11, FIG. 14 is a schematic view of the display module shown in FIG. 11 with a part of structure removed, and FIG. 15 is a schematic view of the display module shown in FIG. 11 with another part of the structure removed. The display module 300 includes a display 26, a reflector 27, and a lens group 28 shown in FIGS. 2A and 2B. The second light beam emitted by the display 26 is reflected by the reflector 27, and sequentially passes through the lens assembly 28, the prism module 10 and the eyepiece unit 22, so that the user can view the image generated by the display 26 through the eyepiece unit 22.

The lens assembly 28 includes a lens barrel assembly and plural lenses disposed in the lens barrel assembly. In the illustrated embodiment, the lens barrel assembly includes a first lens barrel 281, a second lens barrel 282, a first lens 283 fixedly disposed in the first lens barrel 281, a second lens 284 fixedly disposed in the second lens barrel 282, and a third lens 285 also fixedly disposed in the second lens barrel 282. The second lens barrel 282 may be a focusing lens barrel that can move relative to the first lens barrel 281 to achieve focusing. The lens assembly 28 further includes a connecting seat 286. The connecting seat 286 includes a first connecting portion 2861 and a second connecting portion 2862 angled with respect to the first connecting portion 2861. The first connecting portion 2861 is used to connect the lens barrels 281 and 282, and is provided with a hole for light to pass through. A connecting post 2811 provided on the outer periphery of the first lens barrel 281 is extended radially, while a connecting groove 2861a provided on the side circumference of the first connecting portion 2861 is extended in the axial direction of the lens barrels 281 and 282. The connecting post 2811 can be moved along the connecting groove 2861a to adjust the positions of the lens barrels 281 and 282 and then fixed.

The second connecting portion 2862 is used to fix the reflector 27. The entire connecting seat 286 is fixed to the first base element 101 of the optical device through the middle portion 2863 connected between the first connecting portion 2861 and the second connecting portion 2862.

The display 26 includes a first optical element 261, a first optical element carrier 262 for supporting the first optical element 261, a second base element 263 which is kept fixed, and an adjustment assembly 264 disposed between the first optical element carrier 262 and the second base element 263. The adjustment assembly 264 is used to adjust the first optical element carrier 262, thereby adjusting the light emitted by the first optical element 261. In this embodiment, the first optical element 261 is a display unit.

The adjustment assembly 264 includes a connecting element 266. The first optical element carrier 262 is movably connected to the first base element 101 through the second base element 263. The first optical element carrier 262 and the second base element 263 can only move relative to each other in a predetermined direction. The predetermined direction can be the light emitting direction of the first optical element 261, that is, a direction perpendicular to the display surface of the first optical element 261. In the illustrated embodiment, a connecting element 266 is provided on the second base element 263, and a guide hole 267 is provided on the first optical element carrier 262. The connecting element 266 and the guide hole 267 cooperate with each other, and both extend in the first direction perpendicular to the display surface of the first optical element 261. Alternatively, the guide hole is provided on the second base element 263, and the connecting element is provided on the first optical element carrier 262.

The adjustment assembly 264 further includes an adjustable element 2641 and an elastic element 2642. The adjustable element 2641 passes through the first optical element carrier 262 and adjustably engages with the second base element 263. The elastic element 2642 is placed between and against the first optical element carrier 262 and the second base element 263 and constantly exerts an elastic force on the first optical element carrier 262 in a direction away from the second base element 263. When the adjustable element 2641 is adjusted, the first optical element carrier 262, under the action of the elastic element 2642, is moved along the guide hole 267, thereby adjusting the distance between the first optical element 261 and the second base element 263 and adjusting the focal length.

In this embodiment, the adjustable element 2641 is a bolt, and the elastic element 2642 is a spring disposed around the bolt. A through hole 2621 is provided in the first optical element carrier 262, and a receiving hole 2631 is provided in the second base element 263. The lower portion of receiving hole 2631 is provided with inner threads that mates with the adjustable element 2641, and the spring is disposed in the upper portion of receiving hole 2631.

The first optical element carrier 262 further includes a fixing portion 2622 and a second connecting element 2623. The fixing portion 2622 is bent in a direction perpendicular to the display surface of the first optical element 261. A second adjustment groove 2624 extending in the first direction is provided on the fixing portion 2622. The second connecting element 2623 passes through the second adjustment groove 2624 and is fixed to the second base element 263 thereby tightly holding the first optical element carrier 262. During the adjustment process, the second connecting element 2623 is loosened, the distance between the first optical element 261 and the second base element 263 is adjusted, and the second connecting element 2623 slides along the second adjustment groove 2624. After the adjustment is completed, the second connecting element 2623 is tightened to fix the first optical element carrier 262.

The second base element 263 is fixed to the main body of the optical device through a connecting element 265. A first adjustment groove 2632 extending in the first direction is provided on the second base element 263. The connecting element 265 passes through the first adjustment groove 2632, and is fixed to the main body of the optical device so as to tightly holding the second base element 263. By loosening the connecting element 265, the position of the second base element 263 relative to the main body of the optical device can be adjusted in the first direction. Then, the connecting element 265 is fixed to the main body of the optical device.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical device, comprising:
a prism module;
a base element connected to the prism module;
a first optical element;
a first optical element carrier connected to the base element and configured to carry the first optical element;
an adjustment assembly comprising an adjustable element, an elastic element, and a connecting element;
wherein the adjustable element and the connecting element respectively pass through the first optical element carrier and are movably connected to the base element;
wherein the elastic element is placed between and against the first optical element carrier and the base element;
wherein the first optical element carrier is moved along the connecting element or is rotated about the connecting element, when the adjustable element is adjusted related to the base element so as to adjust an elastic force of the elastic element applied to the first optical element carrier and the base element.

2. The optical device as claimed in claim 1, wherein the adjustable element is connected to the base element through threads, and the elastic element is disposed around the adjustable element.

3. The optical device as claimed in claim 1, wherein the first optical element is configured to reflect light to the prism module, to reflect light coming from the prism module, or to emitting light to the prism module.

4. The optical device as claimed in claim 1, wherein:
the first optical element carrier is provided with an opening;
the adjustable element is configured to pass through the opening of the first optical element carrier and is connected to the base element;
the adjustable element comprises a portion contained in the opening, and the opening is larger than the portion of the adjustable element.

5. The optical device as claimed in claim 4, wherein the opening of the first optical element carrier is configured for allowing the first optical element carrier to rotate with respect to the adjustable element when the first optical element carrier 102 is rotated with respect to the base element.

6. The optical device as claimed in claim 1, further comprising:
a printed circuit board assembly comprising a shielding cover and a printed circuit board disposed therein;
a light emitter electrically connected to the printed circuit board for emitting light to the first optical element.

7. The optical device as claimed in claim 6, further comprising a limiting element;
wherein the limiting element is a pressing plate which is bent as a whole;
wherein the limiting element comprises a printed-circuit-board-assembly limiting portion, a carrier limiting portion, and an intermediate portion connected therebetween;
wherein the carrier limiting portion is fixedly connected to the base element, and holds the connecting element of the first optical element carrier;
wherein the printed-circuit-board-assembly limiting portion is propped against the printed circuit board assembly so that the printed circuit board assembly is limited from movement in a second direction and is movable in a first direction and in a third direction;
wherein the connecting element is axially extended in the first direction;
wherein the second direction is perpendicular to the first direction.

8. The optical device as claimed in claim 7, wherein:
the printed-circuit-board-assembly limiting portion and the intermediate portion have an included angle which is equal to or less than 90°;
the second direction and the third direction are perpendicular to the first direction.

9. The optical device as claimed in claim 1, further comprising:
a printed circuit board assembly comprising a shielding cover and a printed circuit board disposed therein;
a light receiver electrically connected to the printed circuit board for receiving light reflected by the first optical element.

10. The optical device as claimed in claim 9, further comprising a limiting element;
wherein the limiting element is a pressing plate which is bent as a whole;
wherein the limiting element comprises a printed-circuit-board-assembly limiting portion, a carrier limiting portion, and an intermediate portion connected therebetween;
wherein the carrier limiting portion is fixedly connected to the base element, and holds the connecting element of the first optical element carrier;
wherein the printed-circuit-board-assembly limiting portion is propped against the printed circuit board assembly so that the printed circuit board assembly is limited from movement in a second direction and is movable in a first direction and in a third direction;
wherein the connecting element is axially extended in the first direction;
wherein the second direction is perpendicular to the first direction.

11. The optical device as claimed in claim 10, wherein:
the printed-circuit-board-assembly limiting portion and the intermediate portion have an included angle which is equal to or less than 90°;
the second direction and the third direction are perpendicular to the first direction.

12. The optical device as claimed in claim 1, further comprising:
a printed circuit board assembly comprising a shielding cover and a printed circuit board disposed therein;
wherein the printed circuit board is disposed on the base element;
wherein the printed circuit board is linearly movable with respect to the base element to perform adjustment.

13. The optical device as claimed in claim 12, further comprising a limiting element;
wherein the limiting element is a pressing plate which is bent as a whole;
wherein the limiting element comprises a printed-circuit-board-assembly limiting portion, a carrier limiting portion, and an intermediate portion connected therebetween;
wherein the carrier limiting portion is fixedly connected to the base element, and tightly holds the connecting element of the first optical element carrier;
wherein the printed-circuit-board-assembly limiting portion is propped against the printed circuit board assembly so that the printed circuit board assembly is limited from movement in a second direction and is movable in a first direction and in a third direction;
wherein the connecting element is axially extended in the first direction;
wherein the second direction is perpendicular to the first direction.

14. The optical device as claimed in claim 13, wherein:
the printed-circuit-board-assembly limiting portion and the intermediate portion have an included angle which is equal to or less than 90°;
the second direction and the third direction are perpendicular to the first direction.

15. The optical device as claimed in claim 1, wherein:
the base element comprises a shaft;
the first optical element carrier comprises a first supporting portion, a connecting element, and an adjustment assembly connecting portion;
the first supporting portion is configured to support the first optical element;
the connecting element is connected to the first supporting portion;
the connecting element is rotatably connected to the shaft of the base element;
the adjustment assembly connecting portion is fixedly connected to at least one of the first supporting portion and the connecting element;
the adjustable element is configured to pass through the adjustment assembly connecting portion and is adjustably connected to the base element.

16. The optical device as claimed in claim 1, further comprising:
a carrier connecting portion fixed to the base element;
wherein the connecting element is disposed on one of the carrier connecting portion and the first optical element carrier, and a hole is provided on the other of the carrier connecting portion and the first optical element carrier to cooperate with the connecting element;
wherein the connecting element is axially extended in a first direction.

17. The optical device as claimed in claim 16, wherein:
the first optical element carrier is provided with an opening;
the adjustable element is configured to pass through the opening of the first optical element carrier;
the first optical element carrier includes a main body, a lug, and a first supporting portion;
the lug is extended perpendicular to the first direction;
the hole cooperating with the connecting element is provided on the lug;
the lug is connected to a first side edge of the main body and is linearly movable along the connecting element and in the first direction;
the first supporting portion is connected to a second side edge of the main body for supporting the first optical element;
the opening on the first optical element carrier is disposed close to a third side edge of the main body.

18. The optical device as claimed in claim 16, further comprising:
a lens module disposed between the first optical element and the prism module;
wherein the carrier connecting portion comprises a first portion, a second portion and a third portion;
wherein the first portion is fixed to the base element and is L-shaped;
wherein the second portion is angled with respect to the first portion;
wherein the connecting element is disposed on the second portion;
wherein the third portion is disposed around the lens module, and the lens module is linearly movable with respect to the third portion and in an optical axial direction of the lens module;
wherein the carrier connecting portion defines a lens adjustment groove extended in the optical axial direction of the lens module, and the lens module is configured to cooperate with the lens adjustment groove.

19. The optical device as claimed in claim 1, wherein:
the base element is a second base element;
the optical device further comprises a first base element;
the first optical element carrier is connected to the first base element through the second base element;
the connecting element is disposed on one of the second base element and the first optical element carrier, and a guide hole is provided on the other of the second base element and the first optical element carrier;
the connecting element is configured to cooperate with the guide hole;
the connecting element and the guide hole are both extended in a first direction;
the connecting element is axially extended in the first direction.
